(19) United States
(12) Patent Application Publication
(10) Pub. No.: US 2015/0157037 A1
(43) Pub. Date: Jun. 11, 2015

(54) FERMENTATION PROCESS OF A SUBSTRATE USING A MIXED CULTURE FOR THE PRODUCTION OF AN EDIBLE BIOMASS FOR ANIMAL AND/OR HUMAN CONSUMPTION

(71) Applicant: Lactoscience Inc., Montreal (CA)

(72) Inventor: Raymond LEWANDOWSKI, Saint Hyacinthe (CA)

(21) Appl. No.: 14/560,413

(22) Filed: Dec. 4, 2014

Related U.S. Application Data
(63) Continuation of application No. 13/698,032, filed on Jan. 23, 2013, now abandoned.
(60) Provisional application No. 61/334,827, filed on May 14, 2010.
(60) Provisional application No. 61/405,772, filed on Oct. 22, 2010.

(51) Int. Cl. A23C 21/02; A23K 1/00; A23L 1/20; A23C 19/032; A23L 1/09

(52) U.S. Cl. CPC A23C 21/02; A23C 19/032; A23L 1/09; A23L 1/2008; A23K 1/007; A23Y 2220/35; A23V 2002/00

(57) ABSTRACT

The present invention is directed to processes, combinations, uses and biomass comprising a combination of yeasts and bacterial strains, for the production of consumable biomass from substrates comprising a simple sugar. More particularly, the claimed subject matter includes the use of Lactobacillus fermentum, Kluyveromyces marxianus and Saccharomyces unisporus. The process intends to fix an environmental problem.

### FIELD OF THE INVENTION

The present invention consists of a process allowing the growth of yeasts and bacteria strains on a substrate in a bioreactor, thus resulting in the production of a valuable biomass rich in protein for animal and/or human consumption. This process intends to fix an environmental problem.

### BACKGROUND OF THE INVENTION

Many by-products are a nuisance to the dairy industry, limiting its growth because of environmental problems that these by-products cause, especially those related to getting rid of the whey and/or other by-products, such as the permeate resulting from the extraction of whey proteins. Volumes of these by-products are important, because the manufacture of one kilogram of cheese generates about nine kilograms of whey which contains about 50 g/L of lactose and less than 10 g/L of soluble serous protein. Manufacturing of a ton of cheese generates as much pollution as city with a population of 5000. Wastewater treatment plants do not accept whey and dairy by-products in municipal sewers as they deregulate the microbial flora and induce bulking. It is also forbidden to bury this waste because of its organic charge.

Dairy industries can treat the whey by extracting lactose but letting the mother liquors or by obtaining dehydrated whey protein concentrate. However, these methods do not get rid of the mother liquors which are salted, or permeate rich in lactose. Serous protein extraction is costly, and there is a lack of interest by the market towards lactose products. Membrane processes weakly reduce the lactose problem because they remove only the serous proteins and leave intact the lactose which is the essential constituent of whey. Another solution is to spread the whey over a field but large surfaces are required and it is limited by the Sodium Absorption Ratio (SAR).

It has been estimated that 90% of the chemical oxygen demand (COD) and biochemical oxygen demand (BOD) in whey comes from lactose. Whey COD is estimated to range from 35,000 to 71,000 ppm, while whey BOD ranges from 16,000 to 33,000 ppm, depending on the specific cheese-making process.

Sugars are the main pollutants of these by-products (in whey, lactose represents 75% of the weight of dry ingredients) and are therefore targets for biological processes.

Fermentation by lactose-positive Crabtree-negative yeast or bacteria has been proposed as an efficient approach to reduce the COD and BOD of whey by reducing the sugar content and, to a lesser extent, the protein content.

Fermentations are usually performed with a single strain in fed-batch under optimal conditions of pH, temperature, agitation and dissolved oxygen, under high production controls to insure purity of the strain. For each new batch, the seeding must be done with a new fresh inoculum. However, monoculture, with either yeast or bacteria, has its disadvantages. Each strain is often able to metabolize only one specific substrate. Furthermore, monocultures are more subject to contamination. They therefore need drastic cleanness conditions of operations, rendering the process weak and unstable.

A process in the treatment of industry effluents is described in U.S. Pat. No. 5,811,289A (Lewandowski et al.). The process was tested on an industrial scale over several years. This patent discloses the treatment of effluents containing different sources of sugar with a very large variety of strains in order to get rid of these effluents in an environmentally safe way. However, the process is not intended to start from whey. Furthermore, it may be difficult to obtain approval of governmental regulatory authorities for a product associated with several different strains.

There is still a need to get rid of substrates with a high COD and/or BOD in a safe way for the environment and to obtain edible compositions for human or animal consumption.

### SUMMARY OF THE INVENTION

The invention provides a process for producing a biomass for animal and/or human consumption from a substrate comprising simple sugars, the process comprising the steps of:
a) providing a combination of yeast and bacterial strains
b) mixing the substrate with the strains to obtain a mixture and
c) allowing fermentation of the mixture between about 20 and 50° C. to obtain the biomass.

The invention provides a process as described therein, wherein the substrate is selected from the group comprising dairy products, dairy by-products, pea residues, beet residues and sugar cane residues.

The invention provides a process as described therein, wherein the strains are

a Kluyveromyces marxianus yeast strain deposited at the International Depositary Authority of Canada (IDAC) under the accession number 150709-01;
a Saccharomyces unisporus yeast strain deposited at the IDAC under the accession number 150709-02; and
a Lactobacillus fermentum bacterial strain deposited at the IDAC under the accession number 150709-03.

The invention provides a combination of yeasts and bacteria comprising:
A Kluyveromyces marxianus yeast strain;
A Saccharomyces unisporus yeast strain; and
A Lactobacillus fermentum bacterial strain.

The invention provides a combination of yeasts and bacteria, wherein the strains are
a Kluyveromyces marxianus yeast strain deposited at the International Depositary Authority of Canada (IDAC) under the accession number 150709-01;
a Saccharomyces unisporus yeast strain deposited at the IDAC under the accession number 150709-02; and
a Lactobacillus fermentum bacterial strain deposited at the IDAC under the accession number 150709-03.

The invention provides a use of a combination of yeasts and bacteria comprising:
A Kluyveromyces marxianus yeast strain;
A Saccharomyces unisporus yeast strain; and
A Lactobacillus fermentum bacterial strain
for preparing a biomass edible for humans or animals, by fermentation of a substrate.

The invention provides a biomass obtained by the process of the invention.

### DETAILED DESCRIPTION OF THE FIGURES

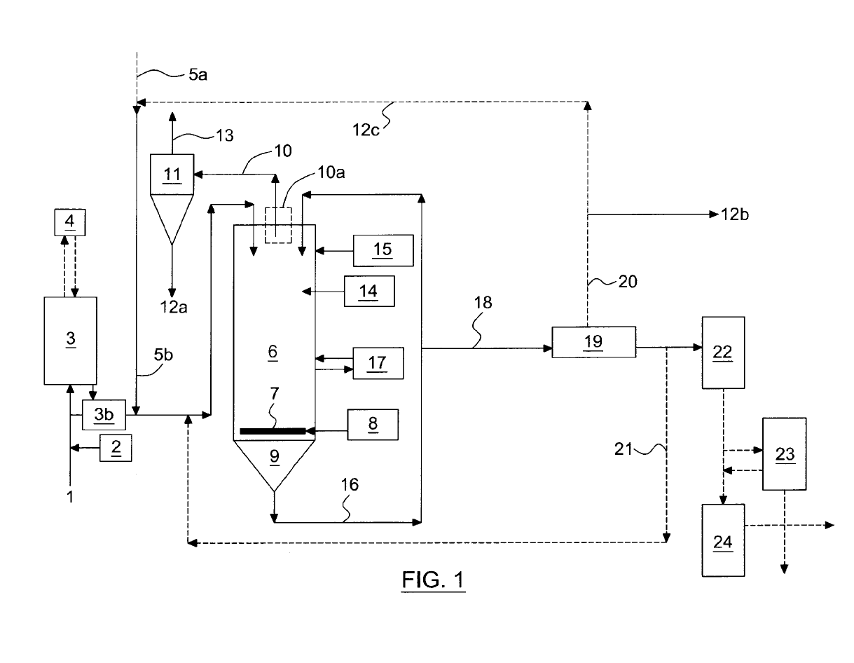

FIG. 1 is a flow sheet diagram of a process, in accordance with a first embodiment of the present invention. Dotted lines represent facultative steps.

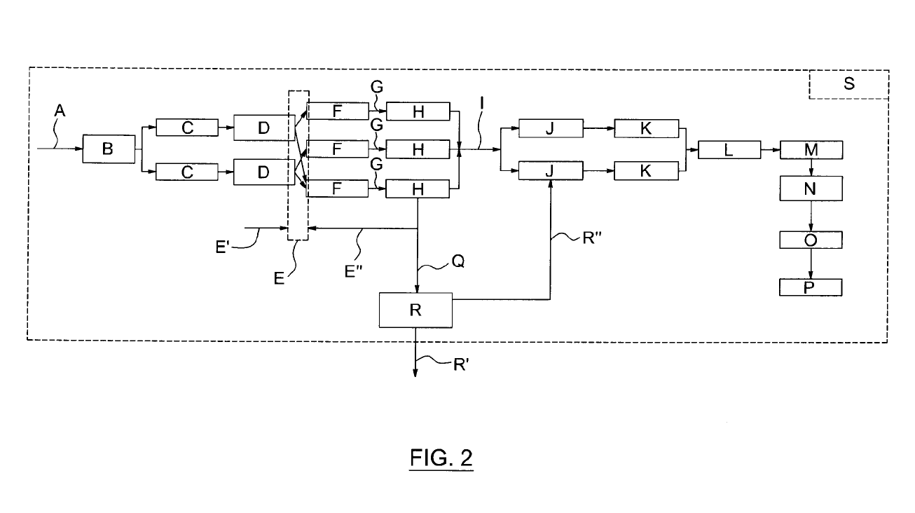

FIG. 2 is a flow sheet diagram of a process, in accordance with a second embodiment of the present invention.

### DETAILED DESCRIPTION OF THE INVENTION

The present invention is a process for the treatment of a substrate containing simple sugars using a co-culture of yeasts and bacteria working in symbiosis for getting rid of these sugars thus reducing the organic charge of the substrate, while obtaining an edible biomass rich in protein for animal or human consumption.

This process allows a strong reduction of the organic charge of the substrate through a biological way: yeast and/or bacterial strains metabolize the components of the substrate and produce a biomass.

Strains.

Strains have been selected for their value in food consumption (production of single cell-protein, prebiotic and/or probiotic effect, Crabtree-negative, high growth yields), their ability to grow in harmony and their ability to metabolize the substrate. This consortium of strains grows on a substrate containing a source of fermentable sugar under specific and astringent conditions.

In one embodiment, these strains contain at least one strain metabolizing the sugar present in the substrate and a second strain using the metabolites or sugar hydrolysed by the first strain.

Strains described in U.S. Pat. No. 5,811,289A (Lewandowski et al.) were isolated. Amongst a large variety of strains, two strains were selected and identified, and a third one added.

In one embodiment of the invention, three different strains are included: two yeasts and one bacterial strain. In one embodiment, the genus of these strains is Kluyveromyces sp., Saccharomyces sp. and Lactobacillus sp. In one embodiment, these strains are Kluyveromyces marxianus, Saccharomyces unisporus and Lactobacillus fermentum. These strains are adapted to fermentation conditions and are able to grow in symbiosis. In one embodiment, in order to reach the best conditions for the process of the present invention, no other strain is added.

Kluyveromyces marxianus

Kluyveromyces marxianus is a species in the genus Kluyveromyces. K. marxianus is used commercially to produce the protease, invertase and lactase enzymes. It is widely used in the food industry, especially in dairy products and bread making. It is a member of the normal human microflora. It grows at 30-45° C. and is able to assimilate lactate.

Yeasts of the Kluyveromyces genus are widely known for their use in industrial scale biomass production and lactose fermentation. K. marxianus has been cited for its ability to efficiently ferment lactose in whey. In conjunction with lactose hydrolysis, a yeast biomass is produced that is a potential source of Single-cell protein (SCP). Kluyveromyces marxianus is reported to have a crude protein content of approximately 50%.

Several studies have also looked at the possibility of using partially purified β-galactosidase (lactase) to reduce the lactose content of whey. Obviously, this approach does not result in biomass production. Kluyveromyces marxianus produces intermediate metabolites that reduce yeast biomass yields.

Saccharomyces unisporus

Saccharomyces unisporus is a yeast which vigorously ferments only some monosaccharides, one of which is galactose. It gives rise to slower and less clean alcoholic fermentation than Saccharomyces cerevisiae, since it produces larger quantities of minor compounds such as glycerol, succinic acid and acetic acid. Saccharomyces unisporus is a low alcohol producer, it cannot bring the grape must fermentation to an end, in fact it halts at a level of 7 vol % in ethanol.

Saccharomyces unisporus is different from Saccharomyces cerevisiae, the baker's yeast representative of the genus. Sacharomyces unisporus forms asci that generally contain a single spore.

Saccharomyces unisporus is found in many foods, including fermented fruit juices and, especially, dairy products. Saccharomyces unisporus is the principal alcoholic fermentation microorganism of traditional koumiss. However, it is an undesirable species in fermented vegetables because it is a non-pathogenic spoilage yeast.

Saccharomyces unisporus has been isolated from fermented milk (kefir, Villi), whey, and cheeses like Armada, Salers cheeses and goat cheeses. Saccharomyces unisporus is present in all these products, but usually at a lower concentration than other yeast species that ferment lactose such as Kluyveromyces spp.

Lactobacillus fermentum

Lactobacillus fermentum is a Gram-positive species of bacterium in the genus Lactobacillus.

Lactobacillus fermentum is an obligatory heterofermentative bacterium that produces CO₂ from glucose and pentoses. The optimum growth temperature of L. fermentum is between 30 and 40° C. Lactobacillus fermentum is phylogenetically a close relative of Lactobacillus reuteri, a food-borne probiotic bacterium. It can be isolated from numerous habitats, including human, chicken, or quail intestines, the mouth, human or rat feces, human breast milk, goats' milk, fermented beets, cheeses, cereal dough, manure, and silage. Many strains of this species are considered probiotics. Several strains have been assayed in clinical trial studies in humans and chickens. Some are commercialized for human intestinal or urogenital applications (e.g., Lactobacillus fermentum RC-14, Chr. Hansen A/S).

These three microbial strains are known to grow at 37° C., at pH7 in either aerobic or anaerobic conditions. All three strains are capable of growing in the Mann Rogosa Sharpe Agar (MRSA) medium. All yeast strains are capable of growing in Tryptic soy agar (TSA) and Potato dextrose agar (PDA) medium. Lactobacillus fermentum is also able to grow on TSA and PDA media, but its growth rate is slower and it forms micro colonies.

In one embodiment, these strains are commercial strains and/or obtained from dairy industries. In one embodiment, the commercial strains are chosen from the following Table 1:

| Strains | International collection |
|---|---|
| Kluyveromyces | ATCC 10022 |
| marxianus | ATCC 28244 |
| | ATCC 8554 |
| | CBS 6556 |
| | CBS 7894 |
| | CCT 4294 |
| | FII 510700 |
| | IMB3 |
| | NCYC 111 |
| | NRS 5790 |
| | PTCC 5193 |
| | ZIM 1867 |
| Saccharomyces | ATCC 48553 |
| unisporus | ATCC 48555 |
| | ATCC 58440 |
| | BR 174 |
| | BR 180 |
| Lactobacillus | ATCC 8289 |
| fermentum | ATCC 9338 |
| | ATCC 11739 |
| | ATCC 11740 |
| | ATCC 11976 |
| | ATCC 14931 |
| | ATCC 14932 |
| | ATCC 23271 |
| | ATCC 23272 |
| | ATCC 53609 |
| | CRL 722 |
| | CRL 251 |
| | IFO 3956 |

In another embodiment, the invention further relates to the following strains:
A Kluyveromyces marxianus yeast strain deposited at the International Depositary Authority of Canada (IDAC) under the accession number 150709-01;
A Saccharomyces unisporus yeast strain deposited at the IDAC under the accession number 150709-02; and
A Lactobacillus fermentum bacterial strain deposited at the IDAC under the accession number 150709-03.

These strains are resistant to important thermal variations and/or pH variations.

Substrates.

The substrate comes from an edible source for animal or human. The substrate contains fermentable sugars. The substrate has a chemical oxygen demand (COD) ranging from 35,000 to 71,000 ppm and/or a biochemical oxygen demand (BOD) ranging from 16,000 to 33,000 ppm. The substrate includes dairy products and/or dairy by-products such as fresh cheese whey, dehydrated whey, whey permeate, deproteinized whey, mother liquors and the like, delactosed permeate (DLP). Mother liquor is a generic term intended to cover the liquid left after extraction of a soluble substance by crystallisation, obtained through evaporation of the substrate. Despite its name, DLP still contains a lot of lactose.

Whey or milk plasma is the liquid remaining after milk has been curdled (or coagulated) and strained, when milk casein proteins have been precipitated either with rennet (leading to sweet whey, and large grain of curd and then to hard cheese like Cheddar or Swiss) or with acid (leading to acid whey, also called Sour whey, and small grains of curd, and then to acid types of cheese such as cottage cheese). 20% of non-casein proteins (mainly lactoglobulins) are not precipitated through this process, they are soluble and called serous proteins. 80% of these non-casein proteins will precipitate at higher temperatures, within a specific pH range and constitute Ricotta cheese. The 20% of remaining proteins are thermostable.

Permeate is the term used to describe the milk-sugar (lactose) and minerals part of whole milk. Permeate is produced by passing whey through a fine sieve to separate milk sugars and minerals from milk protein and fat at room temperature. Proteins are therefore not denatured as opposed to the Ricotta process.

Mother liquor is the liquid left after crystallisation of sugars contained in the permeate, which has been concentrated through evaporation. The mother liquor has a COD ranging from about 200, 000 to 300 000 ppm and a BOD ranging from about 90,000 to 140,000 ppm. In one embodiment the mother liquor has a COD of about 260,000 and a BOD of about 12,000 ppm.

These substrates contain simple sugars such as hexoses (C-6 sugars), pentoses (C-5 sugars), osides or polyoses, holosides, diholosides (lactose, saccharose, maltose, melibiose) or triholoside (raffinose) which are metabolized by the process while other substances such as proteins and lipids remain almost intact. When they are precipitated or solids, these substances gather together with solids generated by the process to be separated with them at a later stage. The result is an edible biomass for animals and/or human.

The following Table 2 lists the sugars and other compounds assimilated and/or fermented by the strains of the invention.

TABLE 2

| | K. marxianus | S. unisporus | L. fermentum |
|---|---|---|---|
| Glucose | + | + | + |
| Galactose | + | + | + |
| Lactose | + | − | + |
| Saccharose | + | − | + |
| Raffinose | + | − | + |
| Inuline | + | − | − |
| Maltose | − | − | + |
| Melibiose | − | − | + |
| Ethanol | + | − | − |
| Lactic acid | + | − | − |
| Succinic acid | + | − | − |
| Glycerol | + | − | − |
| Sorbitol | + | − | − |
| Mannitol | + | − | − |
| Ribose | + | − | − |
| Arabinose | + | − | − |

In one embodiment, whey is used as the substrate as it is edible. In one embodiment, the substrate is used within 24 hours of its production in order to keep the lactose available. 24 hours after its production, lactic fermentation may arise, inducing a pH reduction, leading to sour whey. Sour whey containing lactic acid is still assimilated by Kluyveromyces marxianus.

Whey is kept at the temperature it was produced in the dairy, i.e. between 30 and 55° C.

In another embodiment, other substrates, such as pea residues, beet residues or sugar cane residues, found in processing plants or candy factories, containing at least one fermentable sugar are used.

Pasteurization.

Upon its delivery, the substrate may be treated to avoid the development of the original flora in the bioreactor. Pasteurization can either be conducted by applying heat or chemical treatment. The heat treatment is applied between about 72 to 75° C. during about 15 to 60 seconds. In one embodiment, the heat treatment is applied at about 72° C., during about 15-25 seconds. With the chemical treatment, from about 50 to 3000 ppm, or in a further embodiment from about 500 to about 800 ppm, of hydrogen peroxide is added to the raw material for a retention time of about 2 to 3 hours. H₂O₂ is added in excess to reach pasteurization, the residual hydrogen peroxide will have no effects on the bioreactor flora due to the presence of the catalase enzyme, and water and O₂ will appear rapidly.

Serous Protein Precipitation.

A higher thermal treatment may be applied (from about 80° C. to about 95° C., in a further embodiment from 90° C. to 95° C., during about 30 seconds to 30 minutes, in a further embodiment during 3 to 5 minutes, or even during 30 seconds to 1 minute, or at about 80° C. for about 5 to 10 minutes), after or instead of pasteurization, to promote recovering of serous proteins by precipitation. For this specific operation, the pH is adjusted to its isoelectric point, between about 3.5 and about 6.5, depending on the time and the temperature of the reaction. In one embodiment, the pH is adjusted between about 3.5 and 5.9. The precipitated proteins are then withdrawn by centrifugation or transferred in the bioreactor thus providing a higher protein level in the final product. Other methods may also be used for the withdrawal of serous protein such as ultrafiltration or nanofiltration.

Dilution.

Substrate is diluted, either with city water or addition of clarified water coming from the centrifuge to reduce the COD to between 28 g/L and 50 g/L and the BOD to between 13 et 23 g/L, allowing a better assimilation of the sugar by microorganisms. In one embodiment, dilution occurs after pasteurization and cooling. In another embodiment, dilution occurs after pasteurization but before cooling.

Fermentation.

Substrate, either pasteurized or unpasteurized, is then treated to reach optimal pH and temperature conditions for the process, including nitrogen based nutrients' addition, such as ammoniac salts, urea or others. Incoming substrate may have a pH ranging from between about 3.3 and 7, but pH will be set between about 1.8 and 5.0 for batch fermentation or between about 1.8 and 4 for continuous fermentation. The strains of the invention are able to sustain important pH variations. Such pH variations may be decided in order to prevent and/or fix a contamination problem, and then the pH is readjusted to its usual value.

The fermentation process of the invention works either in batch mode, fed batch mode or continuous mode. In one embodiment, the fermentation starts with a batch before being in continuous mode.

In batch mode, a fresh culture is used every time the process is started. The bioreactor is filled with the prepared substrate to be fermented. The temperature and pH for microbial fermentation is properly adjusted, and other components are added. Fermentation proceeds, and after the proper time the contents of the bioreactor, are taken out for solid recovery. The bioreactor is cleaned and the process is repeated.

In fed batch mode, the substrate is added gradually to the bioreactor. This fermentation process is used for preserving flora in exponential growth phase. The fermented substrate is not withdrawn until the end of the fermentation. The bioreactor is cleaned and the process is repeated.

In the continuous mode, a volume of substrate is added continuously at various rates to the existing culture in the bioreactor, although feeding can be stopped once most of the fermentable sugar is consumed, while withdrawal of the fermented substrate is performed continuously also. In some cases, it can be kept unfed, under certain circumstances, even though no sugar remains. This state is called dormancy. This mode of operation is useful when there is disruption in raw substrate feeding, to accommodate personnel shifts, management or for other reasons. The dormancy state can be applied in the process, at the fermentation step. To promote dormancy conditions in the bioreactor, temperature is adapted to ensure that the quality of the strains is maintained, while preventing growth of pathogens, aeration is turned off, thus no oxygen is available while pH is either maintained at its usual level for short period of dormancy (a few hours) or reduced for longer period of dormancy (a few days), and agitation is reduced. The temperature is also adjusted depending on the length of the dormancy period. In one embodiment, the temperature is reduced from about 40° C. to about 20° C. (room temperature). In another embodiment, the temperature is reduced to about 4° C. for a longer period of dormancy, up to a year.

Addition of the substrate is performed either from the top or the bottom of the bioreactor. In one embodiment, injection of substrate is done from the top of the bioreactor. Sugar in the substrate is gradually consumed before the liquid, which is the culture itself, and is also called the liquor, is withdrawn at the bottom of the reactor and is then either recirculated in the bioreactor or directed towards a separation system. In one embodiment, the liquor is recirculated by a pump through the recirculation loop of the bioreactor.

The bioreactor is prepared to receive an initial quantity of media including raw material, dilution liquid, microorganisms and ingredients. The operation and control instruments allow for following the initial fermentation's evolution and to set the parameters and conditions adjusted allowing for growth, the parameters and conditions being: pH, dissolved oxygen, temperature, input of nutrients and biocatalyst. When the growth is optimized, the bioreactor is fully loaded. After the adaptation and cell growth stage, supply and recirculation can be activated. Fermentation takes place at a pH between 1.8 and 5.0. Maintaining this low pH limits the intrusion of other strains including any type of pathogens because this condition of operation creates bactericide and/or bacteriostatic conditions.

Fermentation mode is mostly microaerophile but also anaerobic. These two modes are possible because the aeration ramp is placed slightly above the tank's bottom and circulation of the liquor in the bioreactor is performed from the bottom through the top via the recirculation loop of the bioreactor. The generated air bubbles run to the surface, leaving the space below the ramp unfed with oxygen allowing growth of anaerobic species. The ventilation allows yeasts to produce more biomass. Furthermore, no alcohol was produced, due to the use of the Crabtree-negative strain Kluyveromyces marxianus.

The average age of the flora is between about 4 and about 50 hours. In one embodiment, the age of the flora is between 12 and 15 hours. The age of the flora has an impact on the productivity of the biomass and the depuration yield (or the COD reduction). With a younger age, a better biomass production is obtained. With an older age, a better depuration yield (or the COD removal yield) is obtained.

The strains' growth produces an exothermal reaction, producing from about 2000 to about 2300 KWh of calorific energy per ton of sugar, which is able to raise the culture temperature up to about 50° C. but fermentation conditions are generally maintained between about 20 and 50° C., in one embodiment between about 30 and 40° C., or in a further embodiment between about 35 and 40° C., by a cooling system, for optimal growth. The cooling system can be installed either directly within the bioreactor, for example, with serpentines, or externally, with a liquid/liquid heat exchanger. The calorific energy may be used to heat fluids in the plant.

The invention also provides a system composed of means to control the conditions of the process, including a pH probe, a pH meter, pumps for injecting acid or base for regulating the pH, an oxygen probe, an oxygen meter, a temperature meter, a thermal system, a biocatalyst including a nitrogen dosage and an injection system.

Feeding of the bioreactor is managed in accordance with different parameters that control the flow rate input function of the bioreactor. A system of air diffusers placed from the bottom of the tank feeds the liquor with fine bubbles. This aeration system induces oxygenated (over the ramp) and anoxic (under the ramp) zone at a time in the bioreactor. The volume of injected air is kept at a level that maintains the level of oxygen almost to about 0 mg/L, but less than about 3.0 mg/L. Nitrogen based nutrients, a biocatalyst and an antifoaming agent are used in appropriate amounts to support the reaction.

The invention provides aeration means such as a blower powering the air diffusers, including an oxygen source, and a pipe for air to go out and a cyclone for aerating said liquor. It also includes first programming means, controlling said first varying means and including liquor dissolved oxygen detecting and measuring means coupled to said first programming means; an acid metering pump, connected to said bioreactor vessel; means for maintaining the dissolved oxygen content in the culture at a rate at a desired level, (in one embodiment, between about 0 to about 2 mg/L); second programming means, controlling said pump to vary acid injection into said vessel, to maintain pH at a settled point wherein the pH range is maintained between 1.8 and 5.0; a recirculation loop means to induce a movement to the liquor in the bioreactor, therefore it is not necessary to have stirring means such as helix.

Foam formation is a drawback in any bioreactor. The foam may be dispersed either with a foam breaker or a recognized chemical antifoam solution, such as canola oil or milk cream. In one embodiment, the foam is dispersed with the cleaning balls, acting as a foam breaker, providing a jet of liquid. This jet of liquid works well when the foam is mild or not abundant, but it is only partially effective in reducing thick foam or when foam is produced at higher rates.

It is possible, to a certain extent, to customize the composition profile of the final product by adding a biocatalyst into the raw material. Basically, the biocatalyst consists of a predetermined mixture of elements such as minerals, vitamins and others. If the concentration of one of the constituents of the biocatalyst is increased, this component is then more assimilated by the cell, which maintains it as a stored product. In other words, the flora involved in the process takes the mineral element added in sufficient amount and converts it into organic form. For instance, it is possible to produce cells with a higher lysine content or enriched metals such as selenium, chromium or other elements of interest.

Solid/liquid Separation:

Once fermented, the liquor coming out from the bioreactor is separated from its solid phase by an appropriate system. Separation is performed by centrifugation, membranes processes or by any other means of solid-liquid phase separation.

Centrifuged biomass is partly or totally directed in a production tank. In the former case, the other partly centrifuged biomass is brought back toward the bioreactor in order to maintain the concentration of active flora at the level that provides for the complete transformation of sugars.

Thus, the separated biomass composed of cells from flora may contain original precipitated serous protein retained from centrifugation as well as the metabolites resulting from the biological flora reactions, including enzymes adsorbed by the biomass.

The biomass can be accumulated after the separation operation and maintained in a vessel under dormancy mode at room temperature, between pH 1.8 and 5.0, with agitation for many days (or at 20° C. for many weeks or at 4° C. for many months) until ready for further transformation.

The clarified water is either sent to the sewer in an environmentally safe way, as the organic workload is lowered from 80 to 97%, or recirculated in the bioreactor with the aim of diluting the raw material.

A facultative membrane filtration unit is installed and operated at this step. The system will reduce the COD of the clarified water coming out of the centrifuge and will recover all the material the centrifuge was unable to retain. The equipment could be composed of a membrane filtration unit, such as reverse osmosis or nanofiltration.

Biomass Pasteurization:

According to the desired product purpose, the biomass is processed thermally to inactivate the cells, through pasteurization for instance, if so required by regulatory authorities. Pasteurization can be conducted by applying heat treatment of 75° C., 60 seconds holding time. The equipment could be composed of a scraped surface heat exchanger. This type of exchanger is mandatory for pasteurization of thick liquids and sludges.

Alternatively, the biomass is maintained in its liquid or freeze-dried unpasteurized state to preserve the probiotic strain character.

Biomass Drying:

At the end of this process, biomass is either retained in the form of press cake or a liquid and then packed, or concentrated by evaporation and dried by atomization or other means to obtain a paste, powder, flakes or granules.

The invention provides fermented whey, spray dried. In one embodiment, it contains less about 2% of lactose or less. In another embodiment, it contains about 1% of lactose or less. In one embodiment, this product has a moisture level of about 7%. In one embodiment, this product further contains serous proteins. In one embodiment, the product is free of Salmonella, Pseudomonas, Staphylococcus, E. coli, coliforms, Aspergillus flavus, Fusarium and/or spore forming bacteria.

Cleaning in Place (CIP):

The equipment is cleaned and sanitized on a regular basis either manually or using the Cleaning in Place system (CIP), depending on the circumstances. Approved cleaning solutions are alternatively applied between rinsing cycles depending upon the contact time and at defined intervals in order to maintain sanitary conditions of the surfaces. The parameters of use are indicated in the cleaning instructions. In another embodiment, the cleaning of the bioreactor vessel occurs every 3 months. In yet another embodiment, the cleaning occurs every 6 months.

Application.

The process of the invention leads to the production of yeasts and bacteria, which by biosynthesis generate a wide range of products including proteins, oligosaccharides, vitamins and antioxidants, and fermentation metabolites with specific nutritional properties. Such product is a source of nourishment for humans and/or animals, such as livestock or pets, including juvenile animals (piglets, calves, calves of milk, lambs, fish etc.), that require a selective diet.

It may also be used, among others, as a food ingredient, as an alternative for protein substitution at a lower cost, as a flavour enhancer aimed to increase food performance, as a nutritive product with high levels of organic micronutrients, as a lacto-replacer for milk calves or other animals or as a prebiotic for its oligosaccharides content.

Different conditions of operation will lead to the obtaining of liquor with different reduced organic charges and of a biomass with different increased organic charges.

### Example 1

As shown in FIG. 1, substrate is received in piping (1) where acids and bases (2) are added, when necessary, to adjust the pH to the appropriate value before being eventually admitted to a pasteurization system (3).

Optionally, temperature substrate is further raised to ensure the precipitation of serous proteins. This step is achieved with equipment that allows for reaching of required time and temperature conditions (4). Temperature substrate is cooled with a cooling system (3b).

To reduce the organic load, a dilution may be performed by injecting in (5b) city water (5a) or adding clarified water (12c) coming out (20) from the separation system (19).

Substrate is admitted in through the top of the bioreactor vessel (6) that contains the fermenting liquor.

The bioreactor is aerated by a system of air diffusers (7) powered by a blower (8), including an oxymeter.

An area of anoxia (9) is located under the air diffuser (7).

Air coming out of the bioreactor from piping (10), loaded with aerosols and foam, is admitted in the cyclone (11) which ensures the rejection of the condensates of aerosols either to the sewer (12a) or back to bioreactor (6), (through the piping (1) for instance) and expels aerosol-free air outside (13). In one embodiment, the foam first passes through a foam breaker (10a)

The pH is regulated in the bioreactor by a system composed of a probe, a pump, a pH meter, and an acid (14).

Nutrients, nitrogen and biocatalyst are injected into the bioreactor via the storage and injection system (15).

The temperature of the bioreactor is regulated by a cooling system (17).

The liquor of the bioreactor is recirculated through a recirculation loop (16) which prevents sedimentation of the liquor in the bottom of the bioreactor when there is a formation of a dead zone under the air dispensers.

The liquor of the bioreactor is led by piping (18) connected to the recirculation loop to the system for solids separation (19).

Clarified water (20) is redirected to the bioreactor (12c) or sewer (12 b).

A portion of the centrifuged biomass is recycled by piping (21) into the bioreactor. This line is used, if necessary, to seed the bioreactor in a continuous manner.

Concentrated biomass is introduced in the production tank (22).

Depending on the desired product, biomass can be pasteurized by a thermal treatment system (23).

Biomass may be routed to a drying unit (24) by piping or packed under its liquid state or pressed to form a cake.

The installation is fitted with a standard system of cleaning in place, not shown on the drawing.

### Example 2

A bioreactor containing conditioned (i.e. slightly diluted and added with urea and biocatalyst) and skimmed whey is seeded by using the three strains described in the present invention, Kluyveromyces marxianus, Saccharomyces unisporus and Lactobacillus fermentum, at pH 3.5 and to ambient temperature at 20° C. The aeration to which it is subjected causes an increase in the turbidity because of the growth of flora, while the temperature rises. Once the lactose is depleted, the bioreactor is fed with whey continuously. The heat generated by biological reactions is removed by a heat exchanger and a cooling system maintains the temperature between 35° C.

The liquor coming out of the bioreactor is directed towards a centrifuge, which sends the biomass partly in a production tank while another part is recycled in the bioreactor in order to maintain a proper mass load. Clarified water is sent to the sewer. The system is stable and may, thus, remain for a long period without drift. Clarified water does not contain any more lactose, but does contain the major part of serous proteins, which are soluble and, whose flora does take only low molecular weight portion (peptides fraction), remain.

### Example 3

Another embodiment of the process of the invention is shown with example 3 and FIG. 2. The following is a flowchart explanation of the plant operation on a 24 h-7 days/week schedule of the process including the cleaning-in-place system.

### A. Raw Whey Permeate Input

Flow rate: 300 m³/day
Temperature: 20° C. to 35° C.
pH: 3.4 to 6.5
COD: 60-70 g/l

### B. Whey Permeate Buffer Tank

1 whey permeate buffer tank
pH adjustment with caustic or acid solutions

### C. Pasteurization

2 HTST (Hot Temperature Short Time) pasteurizers in parallel operating at the same time or can be used alternately to allow cleaning and production
Pasteurization at 72 to 75° C. with a 15 to 60 seconds holding time

### D. Pasteurized Whey Permeate Buffer Tank

2 pasteurized whey permeate buffer tanks
Can be used alternately to allow cleaning and production at the same time
They must be linked to a heat exchanger to regulate the temperature of whey permeate prior to being pumped in the bioreactors

### E. Whey Permeate Dilution

Dilution may be performed by the injection of city water (E′) or the addition of clarified water (E″) coming from the centrifuges
The aim is to reduce the COD to 30,000 ppm and to allow an optimal biomass production

### F. Bioreactors

3 aerobic/anaerobic bioreactors
Bioreactor temperature must be controlled with a water tower evaporator (30-37° C.)
Heat recovery from bioreactors is possible with heat exchangers
Integrated air injection system should be installed
   G. Liquid Output from Bioreactors
Constituents other than whey permeate are added in the bioreactors during the process, principally city water and clarified water
Suspended solids: 13 to 18 g/l
pH: 4 to 5

### H. Centrifugation

3 centrifuges operating in parallel
Cleaning of one centrifuge can be done while the other two assume production duties, ensuring continuous production and cleaning schedule

### I. Centrifuges Biomass Output

Biomass flow rate: 40 m³/day
Solids content: 15% (w/w)

### J. Biomass Buffer Tank

2 biomass buffer tanks
Can be used alternately to allow cleaning and production at the same time
pH of the biomass is monitored and maintained at a value where the fermentation is stopped and where the contamination is limited
Continuous stirring is required to avoid the solids settling

### K. Biomass Pasteurization

2 scraped surface pasteurizers in parallel operating at the same time or alternately to allow cleaning and production
Pasteurization at 72 to 75° C. with a 15 to 60 seconds holding time
Scraped surface heat exchangers are mandatory for pasteurization of thick liquids and sludge

### L. Pasteurized Biomass Buffer Tank

1 pasteurized biomass buffer tank
Continuous stirring is required to avoid solids settling
Allow continuous feeding of the plate evaporator

### M. Plate Evaporator

Biomass flow rate input: 40 m³/day (15% total solids)
Biomass flow rate output: 24 m³/day (25% total solids)

### N. Concentrated Biomass Buffer Tank

1 concentrated biomass buffer tank
Continuous stirring is required to prevent the solids from settling
Allow continuous feeding of the spray dryer

### O. Spray Drying

Input flow rate: 24 m³/day
Air inlet temperature: 235° C.
Air outlet temperature: 95° C.
Product yield: 6 000 kg/day
Moisture of product: 4% to 6% (w/w)
4˜6% Moisture content
Proteins content: 35 to 40%

### P. Packaging

Manual packaging line
500 kg bulk bags

### Q. Clarified Water

Supernatant inputted from the centrifuges
Suspended solids: 500 mg/l
COD: 12 to 18 g/l

### R. Membrane Filtration Unit

Clarified water (R′) is sent to the municipal sewer
Retentate (R″) is sent to the biomass buffer tank (J)

### S. Cleaning in Place System

### Example 4

Another embodiment of the process of the invention is shown with example 4 and FIG. 2. The following is a flowchart explanation of the plant operation on a 24 h-7 days/week schedule of the process including the cleaning-in-place system.

### A. Raw Whey Permeate Input

Flow rate: 300 m³/day
Temperature: 20° C. to 35° C.
pH: 3.4 to 6.5
COD: 60-70 g/l

### B. Whey Permeate Buffer Tank

1 whey permeate buffer tank
pH adjustment with caustic or acid solutions

### C. Pasteurization

2 HTST (Hot Temperature Short Time) pasteurizers in parallel operating at the same time or can be used alternately to allow cleaning and production
Pasteurization at 72 to 75° C. with a 15 to 60 seconds holding time

### D. Pasteurized Whey Permeate Buffer Tank

2 pasteurized whey permeate buffer tanks
Can be used alternately to allow cleaning and production at the same time
They must be linked to a heat exchanger to regulate the temperature of whey permeate prior to being pumped in the bioreactors

### E. Whey Permeate Dilution

Dilution may be performed by injection of city water (E′) or addition of clarified water (E″) coming from the centrifuges
The aim is to reduce the COD to 50,000 ppm and to allow a more complete assimilation of the sugar

### F. Bioreactors

3 aerobic/anaerobic bioreactors
Bioreactor temperature must be controlled with a water tower evaporator (35-42° C.)
Heat recovery from bioreactors is possible with heat exchangers
Integrated air injection system should be installed
   G. Liquid Output from Bioreactors
Constituents other than whey permeate are added in the bioreactors during the process, principally city water and clarified water from centrifuge
Suspended solids: 18 to 23 g/l
pH: 3 to 4

### H. Centrifugation

3 centrifuges operating in parallel
Cleaning of one centrifuge can be done while the other two assume production duties, ensuring continuous production and cleaning schedule

### I. Centrifuges Biomass Output

Biomass flow rate: 20 m³/day
Solids content: 15% (w/w)

### J Biomass Buffer Tank

2 biomass buffer tanks
Can be used alternately to allow cleaning and production at the same time
pH of the biomass is monitored and maintained at a value where the fermentation is stopped and where the contamination is limited
Continuous stirring is required to avoid solids settling

### K Biomass Pasteurization

2 scraped surface pasteurizers in parallel operating at the same time or alternately to allow cleaning and production
Pasteurization at 72 to 75° C. with a 15 to 60 seconds holding time
Scraped surface heat exchangers are mandatory for pasteurization of thick liquids and sludge

### L Pasteurized Biomass Buffer Tank

1 pasteurized biomass buffer tank
Continuous stirring is required to avoid solids settling
Allow continuous feeding of the plate evaporator

### M Plate Evaporator

Biomass flow rate input: 20 m³/day (15% total solids)
Biomass flow rate output: 12 m³/day (25% total solids)

### N Concentrated Biomass Buffer Tank

1 concentrated biomass buffer tank
Continuous stirring is required to prevent the solids from settling
Allow continuous feeding of the spray dryer

### O Spray Drying

Input flow rate: 12 m³/day
Air inlet temperature: 235° C.
Air outlet temperature: 95° C.
Product yield: 3 000 kg/day
Moisture of product: 4% to 6% (w/w)
4˜6% Moisture content
Proteins content: 40 to 45%

### P Packaging

Manual packaging line
500 kg bulk bags

### Q Clarified Water

Supernatant coming from the centrifuges
Suspended solids: 500 mg/l
COD: 6 to 12 g/l

### R Membrane Filtration Unit

Clarified water (R′) is sent to the municipal sewer
Retentate (R″) is sent to the biomass buffer tank (J)

### S Cleaning in Place System

### Example 5

Whey obtained from a cheddar plant and having a chemical oxygen demand of 71,000 mg/l is received in a continuous mode after dilution down to 28,000 mg/l with city water at a fluid input of 2.5 m3/hr in the bioreactor where there is maintained a constant volume of 30 m3 of liquor. This liquor has been previously seeded with Kluyveromyces marxianus (IDAC 150709-01), Saccharomyces marxianus (IDAC 150709-02), and Lactobacillus fermentum (IDAC 150709-03), at an initial concentration of each strain of 50%/30%/20%, respectively. This ratio will evolve to 60%/20%/10% in the bioreactor.

The recirculated biomass rate is about 40%. At equilibrium, the concentration of suspended matter in the liquor is about 15 g/l and the dryness of the centrifuged biomass is about 15% in w/w.

The average age of the flora is between about 2 and about 50 hours. In one embodiment, the age of the flora is about 12 hours. The gross productivity is about 10 g of biomass, dry basis, per m³ of whey added in the bioreactor.

The reduction yield of the chemical oxygen demand is about 78%.

### Example 6

Whey obtained from a Swiss cheese plant and having a chemical oxygen demand of 58,000 mg/l is received in a continuous mode after dilution down to 50,000 mg/l with city water at a fluid input of 2 m3/hr in the bioreactor where there is maintained a constant volume of 25 m3 of liquor. This liquor has been previously seeded with Kluyveromyces marxianus (IDAC 150709-01), Saccharomyces marxianus (IDAC 150709-02) and Lactobacillus fermentum (IDAC 150709-03), at an initial concentration of each strain of 48%/51.9%/0.1%, respectively. This ratio will evolve to 70%/29.9%/0.1% in the bioreactor.

The recirculated biomass rate is about 25%. At equilibrium, the concentration of suspended matter in the liquor is about 20 g/l and the dryness of the centrifuged biomass is about 18% in w/w.

The average age of the flora is between about 2 and about 50 hours. In one embodiment, the average age of the flora is about 16 hours. The gross productivity is about 9 g of biomass, dry basis, per m3 of whey added in the bioreactor.

The reduction yield of the chemical oxygen demand is about 86%.

### Example 7

The process of the invention has been used with pea residues as the substrate. A reduction of 70% of the COD has been observed. This reduction is less than the one observed with whey as this substrate contains less sugar.

What is claimed is:

1. Process for producing a biomass for animal and/or human consumption from a substrate comprising simple sugars, the process comprising the steps of:
a) providing a combination of yeast and bacterial strains
b) mixing the substrate with the strains to obtain a mixture and
c) allowing fermentation of the mixture between about 20 and 50° C. to obtain the biomass.

2. The process of claim 1, wherein the substrate has a chemical oxygen demand (COD) ranging from 35,000 to 71,000 ppm.

3. The process of claim 1, wherein the substrate has a biochemical oxygen demand (BOD) ranging from 16,000 to 33,000 ppm.

4. The process of claim 1, wherein the substrate is selected from the group consisting of dairy products, dairy by-products, pea residues, beet residues and sugar cane residues.

5. The process of claim 4, wherein the dairy products or by-products are selected from a group consisting of fresh cheese whey, dehydrated whey, whey permeate, deproteinized whey, mother liquors and the like, and delactosed permeate (DLP).

6. The process of claim 1, wherein step a) is preceded by a pasteurization step of the substrate.

7. The process of claim 6, wherein the pasteurization is chemical.

8. The process of claim 7, wherein the pasteurization requires H₂O₂.

9. The process of claim 6, wherein the pasteurization is thermal.

10. The process of claim 9, wherein the pasteurization is conducted by applying a heat treatment of 72° C. for 15-25 seconds.

11. The process of claim 10, wherein the pasteurization induces precipitation of serous proteins.

12. The process of claim 11, wherein the pasteurization is conducted by applying a heat treatment of 85° C. to about 95° C. for 2 to 5 minutes.

13. The process of claim 1, wherein the substrate is diluted before being mixed with the strains.

14. The process of claim 1, wherein the strains contain two yeasts strains and one bacterial strain.

15. The process of claim 1, wherein at least one of the yeasts is Kluyveromyces marxianus.

16. The process of claim 1, wherein at least one of the yeasts is Saccharomyces unisporus.

17. The process of claim 1, wherein the bacterial strain is Lactobacillus fermentum.

18. The process of claim 1, wherein the strains are Kluyveromyces marxianus, Saccharomyces unisporus and Lactobacillus fermentum.

19. The process of claim 1, wherein the strains are
a Kluyveromyces marxianus yeast strain deposited at the International Depositary Authority of Canada (IDAC) under the accession number 150709-01;
a Saccharomyces unisporus yeast strain deposited at the IDAC under the accession number 150709-02; and
a Lactobacillus fermentum bacterial strain deposited at the IDAC under the accession number 150709-03.

20. The process of claim 1, wherein the fermentation is in batch or fed batch.

21. The process of claim 1, wherein the fermentation is continuous.

22. The process of claim 1, wherein the mixture is stirred in a bioreactor allowing the mixture which is at the bottom of the bioreactor to be recirculated through the upper part of the bioreactor.

23. The process of claim 22, wherein the mixture is stirred with air dispensers.

24. The process of claim 22, wherein the mixture is stirred with a recirculation loop.

25. The process of claim 1, wherein fermentation induces foam formation, wherein said foam is broken with a foam breaker or a recognized chemical antifoam solution.

26. The process of claim 1, wherein the recovered biomass is centrifuged to obtain a solid phase and a liquid phase.

27. The process of claim 26, wherein the solid phase is pasteurized and/or dried.

28. A combination of yeasts and bacteria comprising:
A Kluyveromyces marxianus yeast strain;
A Saccharomyces unisporus yeast strain; and
A Lactobacillus fermentum bacterial strain.

29. The combination of claim 28, wherein the strains are
a Kluyveromyces marxianus yeast strain deposited at the International Depositary Authority of Canada (IDAC) under the accession number 150709-01;
a Saccharomyces unisporus yeast strain deposited at the IDAC under the accession number 150709-02; and
a Lactobacillus fermentum bacterial strain deposited at the IDAC under the accession number 150709-03.

30. A biomass obtained by the process of claim 1.

31. The process of claim 11, wherein the pasteurization is conducted by applying a heat treatment of from 90° C. to 95° C. for 3 to 5 minutes.
